(19) United States
(12) Patent Application Publication
(10) Pub. No.: US 2004/0073811 A1
(43) Pub. Date: Apr. 15, 2004

(54) Web service security filter

(76) Inventor: Aleksey Sanin, Sunnyvale, CA (US)

Correspondence Address: GLENN PATENT GROUP, 3475 EDISON WAY, SUITE L, MENLO PARK, CA, 94025, US

(21) Appl. No.: 10/272,225

(22) Filed: Oct. 15, 2002

(51) Int. Cl. G06F 11/30

(52) U.S. Cl. 713/201; 717/143

(57) ABSTRACT

The invention comprises a server-side plug in as a security filter that processes HTTP requests before any other Web service plug-ins or applications. Using a highly customizable set of pattern rules based on regular expressions, the security filter predictably intercepts all attacks of known patterns. The set of rules is updated whenever a new pattern of attack is discovered.

### BACKGROUND OF THE INVENTION

1. Field of the Invention

The invention relates generally to Web service security technology. More particularly, the invention relates to an apparatus and method to protect Web service applications from malicious HTTP request.

2. Description of the Prior Art

The primary Web service security issues include protecting a Web services from unauthorized access or usage and protecting Web application from malicious request from even authorized users.

Aiming at the first security issue, many different approaches such as firewall and packet filters have been developed. The following are some examples of these approaches.

A firewall is a bottleneck between two networks designed to prohibit certain types of internetwork communication such as login attempts and network file system access.

The firewall hardware typically consists of one or more computers, routers, or special-purpose machines. Computers behind the firewall are the local hosts that the firewall protects, and computers outside the firewall are the remote hosts, which are assumed to be potential attackers. TCP connections across the firewall that originate from the Internet are called inbound connections, and those that originate behind the firewall are called outbound connections; in each case, TCP permits full-duplex communications.

U.S. Pat. No. 5,835,726 issued to Shwed, et al disclosed a system for controlling the inbound and outbound data packet flow in a computer network. By controlling the packet flow in a computer network, private networks can be secured from outside attacks in addition to controlling the flow of packets from within the private network to the outside world. A user generates a rule base which is then converted into a set of filter language instruction. Each rule in the rule base includes a source, destination, service, whether to accept or reject the packet and whether to log the event. The set of filter language instructions are installed and execute on inspection engines which are placed on computers acting as firewalls. The firewalls are positioned in the computer network such that all traffic to and from the network to be protected is forced to pass through the firewall. Thus, packets are filtered as they flow into and out of the network in accordance with the rules comprising the rule base. The inspection engine acts as a virtual packet filtering machine which determines on a packet by packet basis whether to reject or accept a packet. If a packet is rejected, it is dropped. If it is accepted, the packet may then be modified. Modification may include encryption, decryption, signature generation, signature verification or address translation. All modifications are performed in accordance with the contents of the rule base. Shwed teaches network and transport layers filtering, focusing on firewalls to prevent unauthorized communication attempts and attacks upon the protected network resources.

U.S. Pat. No. 6,400,707 issued to Baum et al disclosed a method for conducting a voice communication through a hybrid network including a packet internetwork connected to a circuit switched telephone network. The packet internetwork is connected to the switched telephone network through a static filter device, a packet switch, and a telephone network controlled gateway. A control processor is connected to the packet switch and to the filter device. The filter device generates a real time copy of call set up signaling dialog between the party requesting connection and the gateway passing through or to the filter device. This duplicate of set up signaling is delivered from the filter device through the packet switch to the control processor. The control processor generates a filter device control signal specifying the filter parameters derived from the set-up signaling dialog. The filter device control signal is delivered to the filter device and reconfigures the filter device to set filter parameters which are customized to the specific communication. The filter device filters the conversation stream of packetized voice signaling to enforce conformance to automatically created filter parameters which are customized on a per-conversation basis.

David Martin Jr. et al in their paper entitled “Blocking Java Applets at the Firewall,” IEEE, The Proceedings of the 1997 Symposium on Network and Distributed System Security, disclosed a method of protecting a Web site on the Internet against hostile external Java applets while allowing trusted internal applets to run.

These approaches cannot be directly used in solving the security problems in a Web service application caused by HTML tags or script in a dynamically generated page. As an example, consider following PSP template validatePasswordForm.psp that generates a form in HTML page:

```
<form action=“/_cqr/login/validatePassword.psp”>
    <input type=“hidden” name=“status”
value=“<%=query.status%>”>
    <input type=“password” name=“pwd” value=“”>
</form>
```

PSP engine substitutes <%=query.status%> substring with the value of status query parameter. A hacker can construct a link to validatePasswordForm.psp with a query parameter status equal to

“><script>I-will-send-your-cookies-to-hacker
</script><img src=”

Consequently, PSP engine performs a substitution, and in the result HTML page dangerous JavaScript code “I-will-send-your-cookies-to-hacker” is executed (in the context of safe and secure domain my.screenname.aol.com !):

```
<form action=“/_cqr/login/validatePassword.psp”>
    <input type=“hidden” name=“status”
value=“”><script> I-will-send-your-cookies-to-
hacker</script><img src=“”>
    <input type=“password” name=“pwd” value=“”>
</form>
```

To stop up this loophole, the Web service application must validate all user input data and/or generate “safe” HTML output (encode all user supplied data). However, this is a huge task that requires significant development and quality assurance resources.

What is desired is a flexible, easily-tunable mechanism to block known types of attack without re-writing the Web service application from the scratch.

### SUMMARY OF THE INVENTION

The invention provides a server-side plug-in as a security filter that processes HTTP requests before any other Web service plug-ins or applications. Using a highly customizable set of pattern rules based on regular expressions, the security filter predictably intercepts all attacks of known patterns. The set of rules is updated whenever a new pattern of attack is discovered.

Although this solution does not guarantee that the application is shielded from new, undiscovered attack pattern, it empowers a Web service provider to block all attacks of pattern known up to date and keep the pattern list updated when new attacks are found.

The advantage of this solution is that the Web service provider does not need to modify the application to be protected.

### BRIEF DESCRIPTION OF DRAWINGS

FIG. 1 is schematic block diagram illustrating a network wherein an HTTP request is processed by a security filter before it reaches the Web service application according to the invention; and

FIG. 2 is a flow diagram illustrating the basic steps to intercept malicious HTTP request according to the invention.

### DETAILED DESCRIPTION OF THE INVENTION

No matter how a Web system is designed, hackers can almost always find a loophole in it and crack it. Therefore, it is almost impossible to create a hundred percent guaranteed secure system. A high secure system means a well-designed flexible enough system plus permanent monitoring. Known types of attack usually fall in some patterns which rarely appear in regular user input. For example, the dangerous value of status query parameter includes <script> substring. This invention focuses on a server-side standalone filter (NSAPI plug-in), which is used to block the requests that match specified patterns.

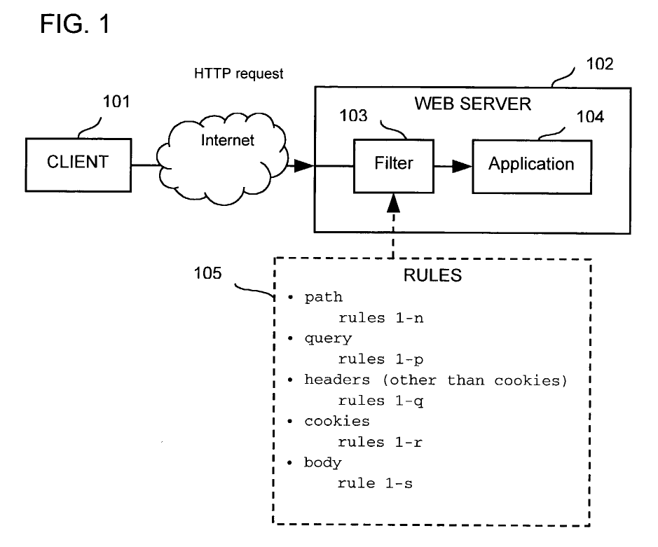

FIG. 1 is schematic block diagram illustrating a network wherein an HTTP request is processed by a security filter before it reaches the Web service application. A user who validly signs in the network via a client 101 coupled to the Internet sends an HTTP request to the Web server 102. The security filter 103 is tuned to specifically protect the Web service application 104. The filter 103 parse the HTTP requests into five categories of objects and inspects the objects category by category. The five categories of objects are:

path

query

headers (other than cookies)

cookies

body

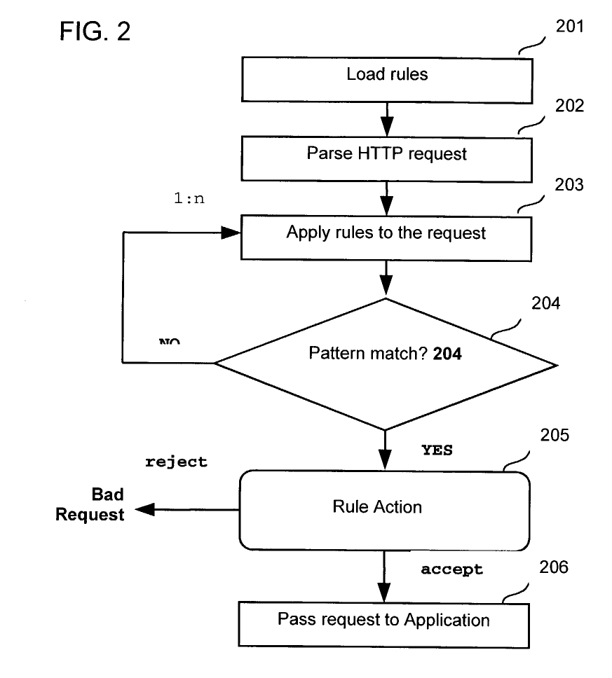

FIG. 2 is a flow diagram illustrating a method to intercept malicious HTTP request according to the invention. The method includes the following steps:

Step 201: Loading a group of predefined pattern rules;

Step 202: Parse an incoming HTTP request according to the objects;

Step 203: Apply the predefined group of pattern rules to said objects; and

Step 204: Check whether any substring included in the objects matches any of the pattern rules; and

Step 205: Take a rule action. For example, accept the request or reject the request because it has been determined as a bad request.

Each object in the HTTP request corresponds to a separate list of pattern rules. The pattern rules in the list are executed sequentially until an object data matches a rule pattern or all rules in the list are completely checked. If an object data matched a rule pattern, then one of the following actions is taken:

accept—stop validating the request and pass it to the Web service application 104;

log—log an error message and continue;

ignore—continue and ignore the matched substring for following checks;

redirect—stop validating the request, log an error message and redirect to a static error page;

return-error—stop validating the request, log an error message and return a given HTTP error code.

If none of the HTTP request objects matches any rule pattern from the pattern lists, then the request is passed to the Web server 102 for further processing. The pattern rules could be applied to plain text HTTP object data, URL decoded data or both. The rule patterns are defined using standard UNIX regular expression and could be case sensitive or not. Table 1 shows the initial list of rule patterns (all patterns are matched ignoring case and to plain and URL decoded data).

TABLE 1

| # | What do we want to block? | Pattern |
|---|---|---|
| 1 | javascript: | javascript[ |
| | | \t\r\n]*: |
| 2 | &{ | \&[ \t\r\n]*\{ |
| 3 | form event handlers: onSubmit, | onSubmit[ |
| | onReset, etc. | \t\r\n]*= |
| 4 | text/mouse input event handlers: | onBlur[ |
| | onBlur, onChange, onFocus, | \t\r\n]*= |
| | onSelect, onMouseClick, etc. | |
| 5 | action= | action[ |
| | | \t\r\n]*= |
| 6 | <script | <[ |
| | | \t\r\n]*script |
| 7 | <frame | <[ \t\r\n]*frame |
| 8 | <iframe | <[ |
| | | \t\r\n]*iframe |

As stated above, it is substantially impossible to provide a 100% guaranteed, seamless, secure system. To reduce bad user experiences when the filter rejects a valid user input, the following can be done:

Perform client-side validation for all user input data from JavaScript and show a friendly error message if the user data could be rejected by the filter described above; and

Make friendly error page to redirect to in the case of error. For example, the error page may include: “To protect your security and privacy . . . Please press Back button and validated your input . . . ”.

The Table 2 shows the average size and maximum size in each object category of the HTTP requests to be processed by the filter.

TABLE 2

| | Average size in | Maximum size in |
|---|---|---|
| Object Category | bytes | bytes |
| Query | 70 | 1150 |
| Headers (w/o cookies) | 480 | 1420 |
| Cookies | 1105 | 5124 |
| Request body (145 out | 300 | 1154 |
| of 14377 requests) | | |
| Total | ˜2000 | ˜8000 |

To check regexp performance, the following benchmark test is executed:

given file is loaded into memory;

string pattern was compiled into internal regexp structure using regcomp ( ) function; and

the regexec ( ) function was called given number of times and total execution time was reported.

Table 3 shows the tests executed on 1 CPU Sun Ultra 2 box. Each test was executed 5 times and all results were very close (around 10% difference).

TABLE 3

| | | | # of | |
|---|---|---|---|---|
| | | | regexec | |
| | | File | calls | Average |
| | | size | per | time |
| Pattern | File | (bytes) | test | (seconds) |
| <script> | /usr/include/stdio.h | 16383 | 10000 | 4 |
| <script> | /u/aleksey/dev/ureg/ui/ | 14375 | 10000 | 5 |
| | generic/en/ | | | |
| | WelcomeLetter.html | | | |
| <( +)script | /usr/include/stdio.h | 16383 | 10000 | 5 |
| (+)>(.*)</( +) | | | | |
| script | | | | |
| (+)>\|< | | | | |
| (+)script | | | | |
| (+)/> | | | | |
| <( +)script | /u/aleksey/dev/ureg/ui/ | 14375 | 10000 | 24 |
| (+)>(.*)</( +) | generic/en/ | | | |
| script | WelcomeLetter.html | | | |
| (+)>\|< | | | | |
| (+)script | | | | |
| (+)/> | | | | |
| (\hat{ }\|[\hat{ }a-zA-Z0- | /usr/include/stdio.h | 16383 | 10000 | 11 |
| 9])the([\hat{ }a-zA- | | | | |
| Z0-9]\|$) | | | | |
| (\hat{ }\|[\hat{ }a-zA-Z0- | /u/aleksey/dev/ureg/ui/ | 14375 | 10000 | 125 |
| 9])the([\hat{ }a-zA- | generic/en/ | | | |
| Z0-9]\|$) | WelcomeLetter.html | | | |
| ,?([\hat{ }=]+)=\“( | /usr/include/stdio.h | 16383 | 10 | 83 |
| [\hat{ }\”]+)\“ | | | | |
| ,?([\hat{ }=]+)=\“( | /u/aleksey/dev/ureg/ui/ | 14375 | 10 | 20 |
| [\hat{ }\”]+)\“ | generic/en/ | | | |
| | WelcomeLetter.html | | | |

These tests indicate that simple pattern rules with small number of matches provide acceptable performance.

The security filter configuration file has an XML-like syntax. The following file describes a simple rule-set that blocks all requests with “Bad JavaScript” string inside query, cookies or HTTP header “SAFE-HEADER”:

```
<!-- This is a simple rules set --!>
<SetDefault name=“HttpErrorRule/error” value=“500” />
<DefineList name=“block-bad-script”>
    <HttpErrorRule pattern=“Bad +JavaScript” />
</DefineList>
<!-- Apply rules list “block-bad-script ” to HTTP query
string --!>
<ProtectObject type=“query”>
    <IncludeList name=“block-bad-script ”/>
</ProtectObject>
<!-- Apply rules list “block-bad-script ” to HTTP cookies
string --!>
<ProtectObject type=“cookies”>
    <IncludeList name=“block-bad-script ”/>
</ProtectObject>
<!-- Apply rules list “block-bad-script ” to SAFE-HEADER
string --!>
<ProtectObject type=“header” name=“SAFE-HEADER”>
    <IncludeList name=“block-bad-script ”/>
</ProtectObject>
```

Table 4 illustrates the tags used for the filter.

TABLE 4

| Tag | Parent tag | Description | Parameters | Body |
|---|---|---|---|---|
| <!-- . . . --!> | none | Comment tag | — | — |
| | | allows to include | | |
| | | human readable | | |
| | | comments into the | | |
| | | rules file. This tag | | |
| | | has pseudo XML | | |
| | | syntax. | | |
| <SetDefault> | none | Sets default | name - the | If the value |
| | | values for some | full tag | parameter is |
| | | <*Rule> tags | parameter | not specified |
| | | parameters. | name in the | then the body |
| | | | form: | of this tag is |
| | | | tag- | used instead. |
| | | | name/tag- | |
| | | | parameter- | |
| | | | name | |
| | | | value - the | |
| | | | value of the | |
| | | | parameter | |
| <IncludeFile> | none | Includes the rules | name - the | — |
| | | from specified file | include file | |
| | | in the current file. | name | |
| <DefineList> | none | Defines the rules | — | The body of |
| | | list and assigns a | | this tag |
| | | name to it. Each | | contains one |
| | | rules list name | | or more |
| | | must be unique in | | <*Rule> tags |
| | | current context | | or |
| | | (otherwise and | | <IncludeList>. |
| | | error is | | |
| | | generated). | | |
| <ProtectObject> | none | Defines the list of | name - the | The body of |
| | | rules that will be | full name of | this tag |
| | | applied to | the object^{*)} | contains one |
| | | specified HTTP | | or more |
| | | request item | | <*Rule> tags |
| | | (path, query, | | or |
| | | body, cookie | | <IncludeList>. |
| | | value or header | | |
| | | value). | | |
| <IncludeList> | <DefineList> or | Includes the rules | name - the | If the name |
| | <ProtectObject> | from list with given | name of the | parameter is |
| | | name into parent | list defined | not specified |
| | | rules list. | with | then the body |
| | | | <DefineList> | of this tag is |
| | | | before | used instead. |
| <IgnoreRule> | <DefineList> or | Defines the rule | pattern - the | If the pattern |
| | <ProtectObject> | that will exclude | rule pattern | parameter is |
| | | matched substring | to be | not specified |
| | | from followed | matched | then the body |
| | | rules match. | flags**) - | of this tag is |
| | | | (optional) the | used instead. |
| | | | pattern flags | |
| | | | for regcomp | |
| | | | (see below) | |
| | | | encoding**) - | |
| | | | (optional) the | |
| | | | data | |
| | | | encoding to | |
| | | | which the | |
| | | | rule should | |
| | | | be applied | |
| <RemoveRule> | <DefineList> or | Defines the rule | pattern - the | If the pattern |
| | <ProtectObject> | that will remove | rule pattern | parameter is |
| | | matched substring | to be | not specified |
| | | from the current | matched | then the body |
| | | item. | flags**) - | of this tag is |
| | | ATTENTION: | (optional) the | used instead. |
| | | These rules | pattern flags | |
| | | must be listed | for regcomp | |
| | | before any other | (see below) | |
| | | rules. | encoding**) - | |
| | | These rules | (optional) the | |
| | | usually takes | data | |
| | | much more time | encoding to | |
| | | than any other | which the | |
| | | rules because | rule should | |
| | | after successful | be applied | |
| | | match we are | | |
| | | restarting the | | |
| | | current item | | |
| | | validation from the | | |
| | | beginning. | | |
| | | The rule applies | | |
| | | only to plain | | |
| | | encoding. | | |
| | | If you are using | | |
| | | NES server and | | |
| | | NSAPI security | | |
| | | filter then you | | |
| | | should know that | | |
| | | applying | | |
| | | <RemoveRule> to | | |
| | | the body of HTTP | | |
| | | request means | | |
| | | using a “hacking” | | |
| | | implementation. I | | |
| | | could not promise | | |
| | | that it'll work with | | |
| | | all NES versions | | |
| | | on all platforms. | | |
| | | You are warned! | | |
| <AcceptRule> | <DefineList> or | Defines the rule | pattern - the | If the pattern |
| | <ProtectObject> | that will stop all | rule pattern | parameter is |
| | | further request | to be | not specified |
| | | validation if the | matched | then the body |
| | | pattern will be | flags**) - | of this tag is |
| | | matched. | (optional) the | used instead. |
| | | | pattern flags | |
| | | | for regcomp | |
| | | | (see below) | |
| | | | encoding**) - | |
| | | | (optional) the | |
| | | | data | |
| | | | encoding to | |
| | | | which the | |
| | | | rule should | |
| | | | be applied | |
| <AcceptItemRule> | <DefineList> or | Defines the rule | pattern - the | If the pattern |
| | <ProtectObject> | that will stop all | rule pattern | parameter is |
| | | further request | to be | not specified |
| | | item validation if | matched | then the body |
| | | the pattern will be | flags**) - | of this tag is |
| | | matched. The | (optional) the | used instead. |
| | | validation will | pattern flags | |
| | | continue on next***) | for regcomp | |
| | | request item. | (see below) | |
| | | | encoding**) - | |
| | | | (optional) the | |
| | | | data | |
| | | | encoding to | |
| | | | which the | |
| | | | rule should | |
| | | | be applied | |
| <LogRule> | <DefineList> or | Defines a rule that | pattern - the | If the pattern |
| | <ProtectObject> | will write a | rule pattern | parameter is |
| | | message into the | to be | not specified |
| | | log if the pattern | matched | then the body |
| | | will be matched. | flags**) - | of this tag is |
| | | | (optional) the | used instead. |
| | | | pattern flags | |
| | | | for regcomp | |
| | | | (see below) | |
| | | | encoding**) - | |
| | | | (optional) the | |
| | | | data | |
| | | | encoding to | |
| | | | which the | |
| | | | rule should | |
| | | | be applied | |
| | | | message**) - | |
| | | | the message | |
| | | | to be written | |
| | | | into the log | |
| | | | level**) - | |
| | | | (optional) the | |
| | | | message log | |
| | | | level (not | |
| | | | supported | |
| | | | yet) | |
| <RedirectRule> | <DefineList> or | Defines a rule that | pattern - the | If the pattern |
| | <ProtectObject> | will redirect user | rule pattern | parameter is |
| | | to specified URL if | to be | not specified |
| | | the pattern will be | matched | then the body |
| | | matched. | flags**) - | of this tag is |
| | | | (optional) the | used instead. |
| | | | pattern flags | |
| | | | for regcomp | |
| | | | (see below) | |
| | | | encoding**) - | |
| | | | (optional) the | |
| | | | data | |
| | | | encoding to | |
| | | | which the | |
| | | | rule should | |
| | | | be applied | |
| | | | url**) - the url | |
| | | | to redirect to | |
| <HttpErrorRule> | <DefineList> or | Defines a rule that | pattern - the | If the pattern |
| | <ProtectObject> | will return an | rule pattern | parameter is |
| | | HTTP error code if | to be | not specified |
| | | the pattern will be | matched | then the body |
| | | matched. | flags**) - | of this tag is |
| | | | (optional) the | used instead. |
| | | | pattern flags | |
| | | | for regcomp | |
| | | | (see below) | |
| | | | encoding**) - | |
| | | | (optional) the | |
| | | | data | |
| | | | encoding to | |
| | | | which the | |
| | | | rule should | |
| | | | be applied | |
| | | | error**) - the | |
| | | | http error | |
| | | | code to | |
| | | | return to user | |
| | | | message**) - | |
| | | | (optional) the | |
| | | | message the | |
| | | | user will see | |

*)The full name of <ProtectObject> could be one of the following:
path
query
body
header/header-name
cookie/cookie-name
**)These parameters could be specified using <SetDefault> tag.
Tag rules must be listed before any other rules.
***)HTTP request items are validated in the following order:
path
query
body
headers
cookie
For example, if <AcceptItemRule> rule was matched for query, then jumping to body. If this rule was matched while processing a header, then jumping to next header or to the first cookie.

The common <*Rule> tags parameters include pattern, flags, and encoding.

The “pattern” is a pattern for C regexp ( ) function.

The “flags” is a comma separated list of flags for regcomp ( ) function as shown in Table 5:

TABLE 5

| | |
|---|---|
| default | Default value used if this parameter is not specified; |
| | equal to “extended, icase”. |
| extended | Use Extended Regular Expressions (REG_EXTENDED |
| | flag for regcomp( ) function). |
| icase | Ignore case in match (REG_ICASE flag for |
| | regcomp( ) function). |
| nosub | Report only success/fail (REG_NOSUB flag |
| | for regcomp( ) function). |
| newline | Change the handling of NEWLINE characters |
| | (REG_NEWLINE flag for regcomp( ) function). |
| none or an | Pass 0 to regcomp |
| empty string | |

The “encoding” is a comma separated list of encodings to which this rule will be applied as shown in Table 6.

TABLE 6

| | |
|---|---|
| default | Default value used if this parameter is not specified; |
| | equal to “plain, url-decode”. |
| plain | Apply the rule to the clear string as it is in the request. |
| url-decode | URL decodes the data string and applies the rule. |
| none or an | The rule will never be matched. |
| empty string | |

The following is exemplary configuration file used for the security filter:

```
<!-- Example NSAPI security filter plugin configuration
file to reject some known
“malicious HTML tags or script in a dynamically generated
page” attacks --!>
<SetDefault name=“RedirectRule/url”>
    /error.html
</SetDefault>
<!--
Files access rules:
    - we do not want to check requests to *.html, *.gif,
*.css, *.htm, *.js, *.jpg files
    - we do want to protect *.psp and *.tmpl files
    - nobody should be able to access other files (*.dwt,
*.pdf, *.pl, *.props, *.psd, *.txt, *.xml, etc)
--!>
<DefineList name=“allowed-files”>
    <AcceptRule name=“allow-html” encoding=“plain”
pattern=“\.html$” />
    <AcceptRule name=“allow-gif” encoding=“plain”
pattern=“\.gif$” />
    <AcceptRule name=“allow-css” encoding=“plain”
pattern=“\.css$” />
    <AcceptRule name=“allow-htm” encoding=“plain”
pattern=“\.htm$” />
    <AcceptRule name=“allow-js” encoding=“plain”
pattern=“\.js$” />
    <AcceptRule name=“allow-jpg” encoding=“plain”
pattern=“\.jpg$” />
</DefineList>
<DefineList name=“protected-files”>
    <AcceptItemRule name=“protect-psp” encoding=“plain”
pattern=“\.psp$” />
    <AcceptItemRule name=“protect-tmpl” encoding=“plain”
pattern=“\.tmpl$” />
</DefineList>
<ProtectObject name=“path”>
    <IncludeList name=“protected-files”/>
    <IncludeList name=“allowed-files”/>
</ProtectObject>
<!--
The list of dangerouse HTML code that can start
JavaScript, VBScript, etc. In all cases we will redirect
to the same static error page defined in obj.conf
--!>
<DefineList name=“block-scripts”>
    <RedirectRule name=“block-scripts1” pattern=“\&[
\t\r\n]*\{” />
    <RedirectRule name=“block-javascript1”
pattern=“javascript[ \t\r\n]*:” />
    <RedirectRule name=“block-script” pattern=“<[
\t\r\n]*script” />
    <RedirectRule name=“block-javascript2” pattern=“<[
\t\r\n]*javascript” />
    <RedirectRule name=“block-vbscript” pattern=“<[
\t\r\n]*vbscript” />
    <RedirectRule name=“block-livescript” pattern=“<[
\t\r\n]*livescript” />
    <RedirectRule name=“block-mochascript” pattern=“<[
\t\r\n]*mochascript” />
    <RedirectRule name=“block-mocha” pattern=“<[
\t\r\n]*mocha” />
</DefineList>
<!--
Block different kind of form event handlers (as usual
redirect to the same static error page defined in
obj.conf).
The list is not complete!!! Check
http://msdn.microsoft.com/workshop/browser/mshtml/reference/
events/events.asp
and get full list of events before applying to
production.
--!>
<DefineList name=“block-form-events”>
    <RedirectRule name=“block-action” pattern=“action[
\t\r\n]*=” />
    <RedirectRule name=“block-onSubmit”
pattern=“onSubmit[ \t\r\n]*=” />
    <RedirectRule name=“block-onReset” pattern=“onReset[
\t\r\n]*=” />
</DefineList>
<!--
Block different kind of keyboard/mouse event handlers (as
usual redirect to the same static error page defined in
obj.conf).
The list is not complete!!! Check
http://msdn.microsoft.com/workshop/browser/mshtml/reference/
events/events.asp
and get full list of events before applying to
production.
--!>
<DefineList name=“block-input-events”>
    <RedirectRule name=“block-onBlur” pattern=“onBlur[
\t\r\n]*=” />
    <RedirectRule name=“block-onChange”
pattern=“onChange[ \t\r\n]*=” />
    <RedirectRule name=“block-onFocus” pattern=“onFocus[
\t\r\n]*=” />
    <RedirectRule name=“block-onSelect”
pattern=“onSelect[ \t\r\n]*=” />
    <RedirectRule name=“block-onMouseClick”
pattern=“onMouseClick[ \t\r\n]*=” />
</DefineList>
<!--
Block frames (as usual redirect to the same static error
page defined in obj.conf).
--!>
<DefineList name=“block-frames”>
    <RedirectRule name=“block-frame” pattern=“<[
\t\r\n]*frame” />
    <RedirectRule name=“block-frameset” pattern=“<[
\t\r\n]*frameset” />
    <RedirectRule name=“block-iframe” pattern=“<[
\t\r\n]*iframe” />
</DefineList>
<!--
We do not want to check some query parameters (password
and siteState)
which we think are safe
--!>
<DefineList name=“ignore-query-params”>
    <IgnoreRule name=“ignore-password1”
pattern=“\hat{ }password=.*&” />
    <IgnoreRule name=“ignore-password2”
pattern=“&password=.*&” />
    <IgnoreRule name=“ignore-password3”
pattern=“&password=.*$” />
    <IgnoreRule name=“ignore-siteState1”
pattern=“\hat{ }siteState=.*&” />
    <IgnoreRule name=“ignore-siteState2”
pattern=“&siteState=.*&” />
    <IgnoreRule name=“ignore-siteState3”
pattern=“&siteState=.*$” />
</DefineList>
<!--
List all things we want to block
--!>
<DefineList name=“block-list”>
    <IncludeList name=“block-scripts” />
    <IncludeList name=“block-form-events” />
    <IncludeList name=“block-input-events” />
    <IncludeList name=“block-frames” />
</DefineList>
<!--
Define rules to process query string: ignore some query
params and do all other checks
--!>
<ProtectObject name=“query”>
    <IncludeList name=“ignore-query-params” />
    <IncludeList name=“block-list” />
</ProtectObject>
<!--
Define rules to process body (same as query string):
ignore some query params and do all other checks
--!>
<ProtectObject name=“body”>
    <IncludeList name=“ignore-query-params” />
    <IncludeList name=“block-list” />
</ProtectObject>
<!--
We are going to check only cookies we use
--!>
<ProtectObject name=“cookie/WA_TMCJ_S”>
    <IncludeList name=“block-list” />
</ProtectObject>
<ProtectObject name=“cookie/WA_TMCJ_ESK”>
    <IncludeList name=“block-list” />
</ProtectObject>
<!--
Do we want to check something else? If not then we are
done
--!>
```

Although the invention is described herein with reference to the preferred embodiment, one skilled in the art will readily appreciate that other applications may be substituted for those set forth herein without departing from the spirit and scope of the present invention.

Accordingly, the invention should only be limited by the Claims included below.

1. In an HTTP based network, a security filter for shielding a Web service application from malicious HTTP requests, comprising:
a plurality of pattern rules categorized by object types;
means for parsing an incoming request into objects of said object types;
means for applying said pattern rules to said objects; and
means for taking actions on said incoming request when any substring in said objects matches any of said pattern rules.

2. The security filter of claim 1, wherein said object types comprise:
path;
query;
body;
headers; and
cookie.

3. The security filter of claim 1, wherein lists of said pattern rules corresponding to object types are executed sequentially.

4. The security filter of claims 1, wherein said actions comprise any of:
stop validating said incoming request and pass it to said Web service application;
log an error message and continue;
continue and ignore said matched substring for subsequent checks;
stop validating said incoming request, log an error message and redirect to a static error page; and
stop validating said incoming request, log an error message and return a given HTTP error code.

5. The security filter of claim 1, wherein said pattern rules can be applied to any of:
plain text HTTP object; and
URL decoded data.

6. A method for protecting a Web service application from a malicious HTTP request, comprising the steps of:
parsing an incoming HTTP request into objects;
applying a predefined group of pattern rules to said objects; and
taking an action when any substring included in said objects matches any of said pattern rules;

7. The method of claim 6, wherein said group pattern rules are categorized by object types, each object type corresponding to a list of pattern rules and said object types comprising:
path;
query;
body;
headers; and
cookie.

8. The method of claim 6, wherein lists of said pattern rules corresponding to object types are executed sequentially.

9. The method of claim 6, wherein said pattern rules can be applied to any of:
plain text HTTP object; and
URL decoded data.

10. The method of claim 6, wherein said action comprises:
pass said incoming request to said Web service application; and
reject said incoming request.

11. The method of claim 6, wherein said action comprises any of:
stop validating said incoming request and pass it to said Web service application;
log an error message and continue;
continue and ignore said matched substring for subsequent checks;
stop validating said incoming request, log an error message and redirect to a static error page; and
stop validating said incoming request, log an error message and return a given HTTP error code.

12. A computer readable storage medium containing a computer readable code for operating a computer system to perform a method for protecting a Web service application from malicious HTTP requests, said method comprising the steps of:
parsing an incoming HTTP request into objects;
applying a predefined group of pattern rules to said objects; and
taking an action when any substring included in said objects matches any of said pattern rules;

13. The computer readable storage medium of claim 12, wherein said group pattern rules are categorized by object types, each object type corresponding to a list of pattern rules and said object types comprising:
path;
query;
body;
headers; and
cookie.

14. The computer readable storage medium of claim 12, wherein lists of said pattern rules corresponding to object types are executed sequentially.

15. The computer readable storage medium of claim 12, wherein said pattern rules can be applied to any of:
plain text HTTP object; and
URL decoded data.

16. The computer readable storage medium of claim 12, wherein said action comprises:
pass said incoming request to said Web service application; and
reject said incoming request.

17. The computer readable storage medium of claim 12, wherein said action comprises any of:
stop validating said incoming request and pass it to said Web service application;
log an error message and continue;
continue and ignore said matched substring for subsequent checks;
stop validating said incoming request, log an error message and redirect to a static error page; and
stop validating said incoming request, log an error message and return a given HTTP error code.
